(19) United States
(12) Patent Application Publication
(10) Pub. No.: US 2004/0119723 A1
(43) Pub. Date: Jun. 24, 2004

(54) Apparatus manipulating two-dimensional image in a three-dimensional space

(75) Inventors: Yoshitsugu Inoue, Tokyo (JP); Akira Torii, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Renesas Technology Corp., Tokyo (JP)

(21) Appl. No.: 10/454,506

(22) Filed: Jun. 5, 2003

(30) Foreign Application Priority Data
Dec. 18, 2002 (JP) 2002-366040

(51) Int. Cl. G09G 5/00

(52) U.S. Cl. 345/619

(57) ABSTRACT

An apparatus for manipulating a face image such as a portrait which produces visual effects to keep interesting a user with simple processes without requiring preparation of a complex model and a number-crunching process for processing the model is provided.

Boundary determining means (111) determines a boundary used for bending a face image in a vertical direction of a face image. Image manipulating means (116) bends the face image based on the boundary as determined, to make the face image convex or concave locally around the boundary. Thereafter, the image manipulating means (116) rotates the face image about a rotation axis defined so as to extend in a horizontal direction of the face image, and thereafter projects the face image onto a plane. With those procedures, an expression of a face of the face image can be varied.

### BACKGROUND OF THE INVENTION

1. Field of the Invention

The present invention relates to an image manipulating apparatus for transforming an image, and more particularly, to an image manipulating apparatus suitable to implement a mobile phone having a function of manipulating an image of a human face (hereinafter, referred to as a “face image”) such as a portrait.

2. Description of the Background Art

Conventional methods of manipulating a face image such as a portrait used in mobile phones includes a method employing tone change such as reversal in contrast and toning an image in sepia, a method employing synthesization of an image by means of addition of clip arts or frames, and the like. In accordance with those conventional methods, an original shape of an image is not manipulated.

Meanwhile, in order to manipulate a shape of an image in a computer or the like, texture mapping as one technique known in 3-D graphics has conventionally been utilized. According to one conventional method of manipulating a shape of a face image such as a portrait, a two-dimensional texture image is transformed only in a two-dimensional space in texture mapping. According to another conventional method of manipulating a shape of a face image, a three-dimensional model of an object is constructed in a three-dimensional space and then a two-dimensional texture image is applied to each of surfaces forming the model, in texture mapping. The foregoing exemplary conventional methods of manipulating a shape of an image are described in Japanese Patent Application Laid-Open No. 2000-172874, for example.

As such, in accordance with the conventional methods, manipulation of a face image such as a portrait in mobile phones has been accomplished only in a two-dimensional coordinate space in an essential sense. Hence, the conventional methods of manipulating a face image suffer from a disadvantage of having difficulties in keeping interesting users.

In the conventional methods, to keep interesting users requires preparation of a complicated model, resulting in another disadvantage of necessitating a number-crunching process for processing the model.

### SUMMARY OF THE INVENTION

It is an object of the present invention to provide an image manipulating apparatus suitable for manipulating a face image such as a portrait, which can produce visual effects to keep interesting users with simple processes without requiring preparation of a complex model and a number-crunching process for processing the model.

According to the present invention, an image manipulating apparatus includes image entering means, image storing means, boundary determining means, image manipulating means and image displaying means. The image entering means allows a two-dimensional image to be entered. The image storing means stores the two-dimensional image entered through the image entering means. The boundary determining means determines a boundary used for bending the two-dimensional image, on the two-dimensional image stored in the image storing means. The image manipulating means bends the two-dimensional image about the boundary at a desired bending angle and rotates the two-dimensional image about a predetermined rotation axis at a desired rotation angle in a three-dimensional space, to create an image. The predetermined rotation axis is an axis which defines a rotation of the-two dimensional image in a direction of a line of a vision. The image displaying means displays the image created by the image manipulating means.

The image manipulating apparatus can produce visual effects to keep interesting users with simple processes.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view illustrating a structure of an image manipulating apparatus according to a first preferred embodiment of the present invention.

FIG. 2 is a flow chart illustrating a method of manipulating an image according to the first preferred embodiment of the present invention.

FIG. 3 illustrates an original of a face image which is not manipulated according to the first preferred embodiment of the present invention.

FIG. 4 illustrates rotation of the face image according to the first preferred embodiment of the present invention.

FIGS. 5 and 6 illustrate translation of the face image according to the first preferred embodiment of the present invention.

FIGS. 7 and 8 illustrate rotation of the face image according to the first preferred embodiment of the present invention.

FIGS. 9 and 10 illustrate manipulated versions of the face image according to the first preferred embodiment of the present invention.

FIG. 11 is a view illustrating a structure of an image manipulating apparatus according to a second preferred embodiment of the present invention.

### DESCRIPTION OF THE PREFERRED EMBODIMENTS

### First Preferred Embodiment

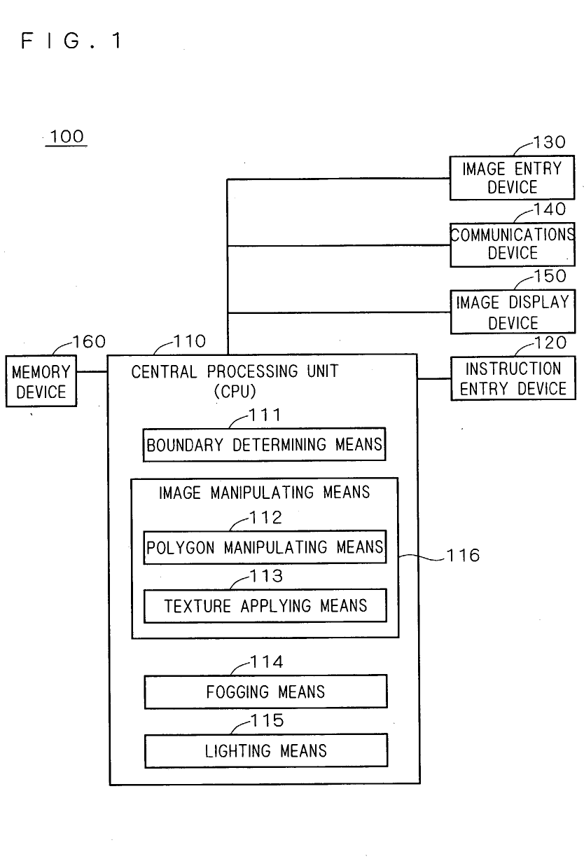

FIG. 1 is a view illustrating a structure of an image manipulating apparatus 100 according to a first preferred embodiment of the present invention. The image manipulating apparatus 100 includes: a central processing unit (CPU) 110; an instruction entry device 120; an image entry device 130; a communications device 140; an image display device 150; and a memory device 160. The central processing unit 110 functions to generally control the image manipulating apparatus 100. The instruction entry device 120 is a keyboard or the like, through which a user enters instructions for the central processing unit 110. The image entry device 130 receives an image from a camera, a scanner, a video camera or the like to enter the received image into the image manipulating apparatus 100. Also an image provided on the Internet can be entered into the image manipulating apparatus 100, through the communications device 140 which transmits/receives an image data or the like. The image display device 150 functions to display an image. The memory device 160 functions to store data. The central processing unit 110 functions to operate as boundary determining means 111, image manipulating means 116 including polygon manipulating means 112 and texture applying means 113, fogging means 114 and lighting means 115, under control in accordance with respective predetermined programs.

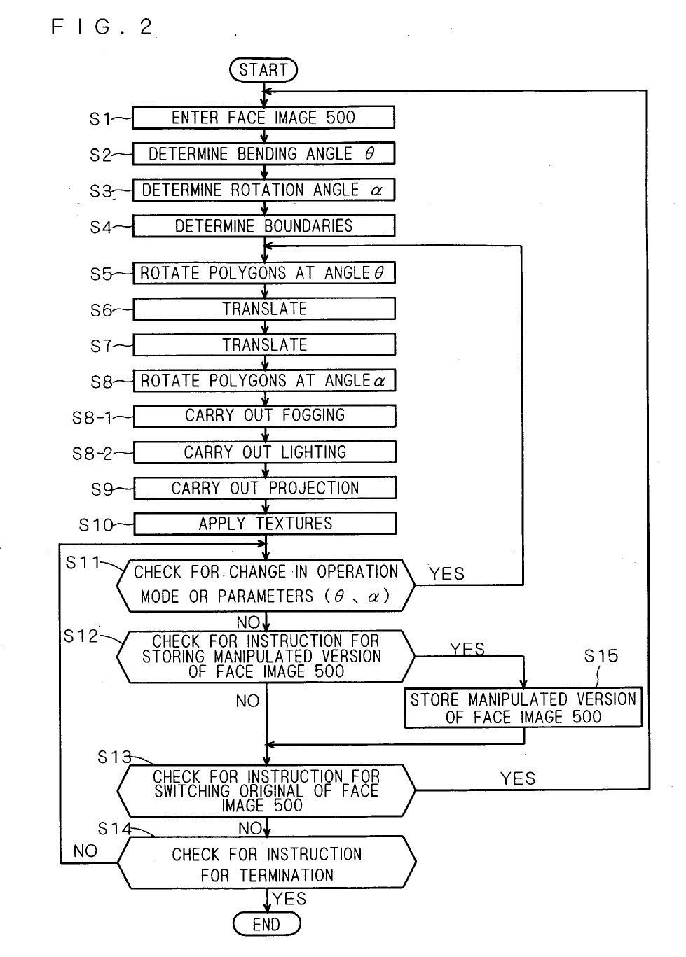

FIG. 2 is a flow chart illustrating a process flow for carrying out manipulation of an image using the image manipulating apparatus 100, which will be described below.

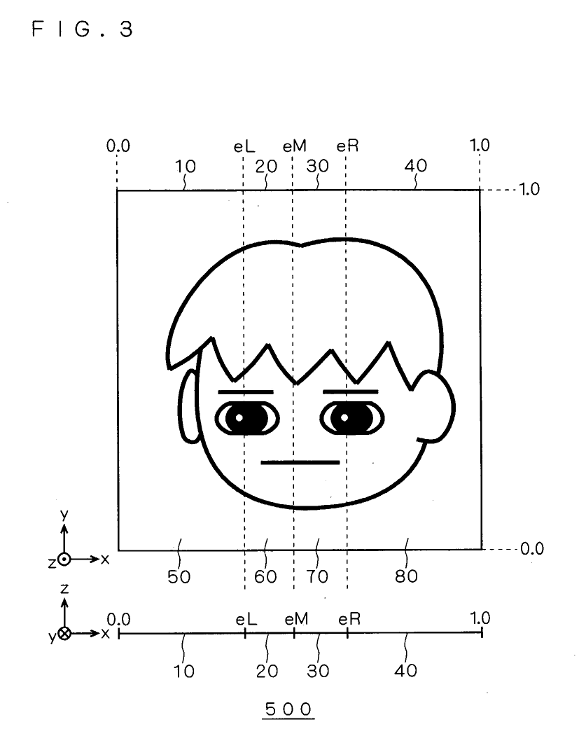

First, in a step S1, a face image 500 as illustrated in FIG. 3, for example, is entered through the image entry device 130. The entered face image 500 is stored in the memory device 160. At that time, by entering and storing a plurality of face images into the memory device 160, it is possible to facilitate a process of switching the face image 500 as an original which is not manipulated, for another one, in a step S13 which will be detailed later.

Next, in a step S2, a desired bending angle θ at which the face image 500 is to be bent vertically (bent in a direction of a y-axis) about a boundary in later steps S5, S6 and S7 is determined by receiving a corresponding value entered by the user through the instruction entry device 120.

In a step S3, a desired rotation angle α at which the bent face image 500 is to be rotated about an x-axis, in other words, in a direction of a line of vision of the user, in a later step S8 is determined by receiving a corresponding value entered by the user through the instruction entry device 120.

In a step S4, the boundary determining means 111 determines three boundaries used for bending the face image 500. The three boundaries extend vertically on the face image 500. It is noted that a horizontal direction and a vertical direction of the face image 500 are assumed to be an x-axis and a y-axis, respectively, as illustrated in FIG. 3, in the instant description. It is further assumed that an x-coordinate of each point at a left edge of the face image 500 is 0.0, an x-coordinate of each point at a right edge of the face image 500 is 1.0, a y-coordinate of each point at a bottom edge of the face image 500 is 0.0, and a y-coordinate of each point at a top edge of the face image 500 is 1.0. The user enters arbitrary values into the instruction entry device 120 while observing the face image 500 displayed on the image display device 150, to specify a coordinate eL and an coordinate eR which are x-coordinates of respective positions of right and left eyes of a face in the face image 500. The boundary determining means 111 determines the coordinates eL and eR as specified by the user, and further determines a coordinate eM by using the following equation (1).

eM=(eR+eL)/2 (1)

The face image 500 is divided into four rectangles by straight lines x=0.0, x=eL, x=eM, x=eR and x=1.0. Referring to FIG. 3, by providing a z-axis perpendicular to an x-y plane (defined by the x-axis and the y-axis) and treating the face image 500 as a plane lying on a plane provided when a z-coordinate is 0.0, i.e., the x-y plane, the four rectangles obtained by dividing the face image 500 can be treated as four polygons 10, 20, 30 and 40, respectively, each defined by a set of vertices located at respective coordinate points. The face image 500 is treated as a two-dimensional texture image formed by the polygons 10, 20, 30 and 40 having textures 50, 60, 70 and 80 applied thereto, respectively. The polygon 10 is defined by a vertex 11 having coordinates (0.0, 0.0, 0.0), a vertex 12 having coordinates (0.0, 1.0, 0.0), a vertex 13 having coordinates (eL, 0.0, 0.0) and a vertex 14 having coordinates (eL, 1.0, 0.0). The polygon 20 is defined by a vertex 21 having coordinates (eL, 0.0, 0.0), a vertex 22 having coordinates (eL, 1.0, 0.0), a vertex 23 having coordinates (eM, 0.0, 0.0) and a vertex 24 having coordinates (eM, 1.0, 0.0). The polygon 30 is defined by a vertex 31 having coordinates (eM, 0.0, 0.0), a vertex 32 having coordinates (eM, 1.0, 0.0), a vertex 33 having coordinates (eR, 0.0, 0.0) and a vertex 34 having coordinates (eR, 1.0, 0.0). The polygon 40 is defined by a vertex 41 having coordinates (eR, 0.0, 0.0), a vertex 42 having coordinates (eR, 1.0, 0.0), a vertex 43 having coordinates (1.0, 0.0, 0.0) and a vertex 44 having coordinates (1.0, 0.1, 0.0).

Coordinates of vertices of the textures 50, 60, 70 and 80 are derived by removing z-coordinates from the coordinates of the vertices defining the polygons 10, 20, 30 and 40. Specifically, the texture 50 is defined by a vertex 51 having coordinates (0.0, 0.0), a vertex 52 having coordinates (0.0, 1.0), a vertex 53 having coordinates (eL, 0.0) and a vertex 54 having coordinates (eL, 1.0). The texture 60 is defined by a vertex 61 having coordinates (eL, 0.0), a vertex 62 having coordinates (eL, 1.0), a vertex 63 having coordinates (eM, 0.0) and a vertex 64 having coordinates (eM, 1.0). The texture 70 is defined by a vertex 71 having coordinates (eM, 0.0), a vertex 72 having coordinates (eM, 1.0), a vertex 73 having coordinates (eR, 0.0) and a vertex 74 having coordinates (eR, 1.0). The texture 80 is defined by a vertex 81 having coordinates (eR, 0.0), a vertex 82 having coordinates (eR, 1.0), a vertex 83 having coordinates (1.0, 0.0) and a vertex 84 having coordinates (1.0, 1.0).

Then, in the steps S5 through S10, the coordinates of the vertices of the polygons 10, 20, 30 and 40 are translated and rotated in a three-dimensional space, and thereafter are projected onto a two-dimensional plane. Subsequently, the textures 50, 60, 70 and 80 are applied to the resulting polygons 10, 20, 30 and 40, respectively, (mapping), to complete manipulation of the face image 500. The foregoing processes are carried out by the image manipulating means 116, which will be described in detail below.

First, in the steps S5, S6 and S7, the polygon manipulating means 112 vertically (i.e., in the direction of the y-axis) bends the face image 500 at the bending angle θ. As a result, the polygon manipulating means 112 bends the face image 500 such that the face image 500 is made convexo-concave locally around the straight lines x=eL and x=eR, as well as made concavo-convex locally around the straight line x=eM, in a direction in which the z-axis extends, in the steps S5, S6 and S7.

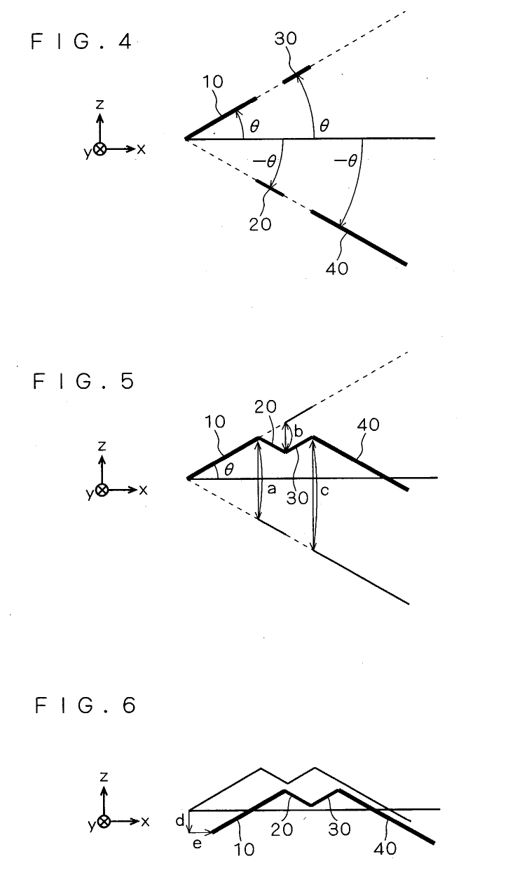

In the step S5, the polygon manipulating means 112 rotates the polygons 10, 20, 30 and 40 about the y-axis as illustrated in FIG. 4. At that time, an angle at which each of the polygons 10 and 30 is rotated is θ, while an angle at which each of the polygons 20 and 40 is rotated is −θ. Coordinate transformation of each of the polygons 10 and 30 associated with the rotation is accomplished by using the following matrix (2), while coordinate transformation of each of the polygons 20 and 40 associated with the rotation is accomplished by using the following matrix (3). It is noted that a matrix used for every coordinate transformation described hereinafter including the coordinate transformations of the polygons 10, 20, 30 and 40 in the step S5 will be represented as a matrix with four rows and four columns (“4×4 matrix”) for the reasons that a matrix used for coordinate transformation associated with perspective projection to be carried out in the later step S9 should be represented as a 4×4 matrix. With respect to the coordinate transformations of the polygons 10, 20, 30 and 40 in the step S5, the corresponding 4×4 matrices (2) and (3) are obtained by using homogenous coordinates known in 3-D graphics, in which a value “1” is added to as a fourth coordinate to the three-dimensional coordinates of the polygons 10, 20, 30 and 40 so that the coordinates of the polygons 10, 20, 30 and 40 are converted into four-dimensional coordinates.

$$\begin{matrix}[ \begin{matrix}cos θ & 0 & - sin θ & 0 \\ 0 & 1 & 0 & 0 \\ sin θ & 0 & cos θ & 0 \\ 0 & 0 & 0 & 1\end{matrix} ] & ( 2 ) \\ [ \begin{matrix}cos θ & 0 & sin θ & 0 \\ 0 & 1 & 0 & 0 \\ - sin θ & 0 & cos θ & 0 \\ 0 & 0 & 0 & 1\end{matrix} ] & ( 3 )\end{matrix}$$

As a result of the rotation at the angle θ or the angle −α in the step S5, the polygons 10, 20, 30 and 40 which have been in contact with one another at their sides are separated from one another. Then, the polygon manipulating means 112 translates the polygons 20, 30 and 40 so as to place the polygons 10, 20, 30 and 40 again in contact with one another at their sides, in the step S6. As illustrated in FIG. 5, the polygons 20, 30 and 40 are translated relative to the polygon 10 in the same direction in which the z-axis extends, with the polygon 10 being kept as it is. Respective distances a, b, c traveled by the polygons 20, 30 and 40 during the translation at that time can be calculated using the following equations (4), (5) and (6), respectively.

a=sin θ×eL×2 (4)

b=sin θ×(eR−eL) (5)

c=a+b (6)

Coordinate transformations of the polygons 20, 30 and 40 associated with the translation in the step S6 are accomplished by using the following matrices (7), (8) and (9), respectively.

$$\begin{matrix}[ \begin{matrix}1 & 0 & 0 & 0 \\ 0 & 1 & 0 & 0 \\ 0 & 0 & 1 & a \\ 0 & 0 & 0 & 1\end{matrix} ] & ( 7 ) \\ [ \begin{matrix}1 & 0 & 0 & 0 \\ 0 & 1 & 0 & 0 \\ 0 & 0 & 1 & - b \\ 0 & 0 & 0 & 1\end{matrix} ] & ( 8 ) \\ [ \begin{matrix}1 & 0 & 0 & 0 \\ 0 & 1 & 0 & 0 \\ 0 & 0 & 1 & c \\ 0 & 0 & 0 & 1\end{matrix} ] & ( 9 )\end{matrix}$$

Due to the translation of the polygons 20, 30 and 40 relative to the polygon 10 in the step S6, the face image 500 is shifted to a position where the x-coordinate of each point on the face image 500 is decreased and the z-coordinate of each point on the face image 500 is increased. This would cause the face image 500 to be somewhat drawn to the left-hand side and magnified when displayed on the image display device 150, having been projected onto the x-y plane in the step S9 described later. Then, the step S7 provides for correction of such shift of the face image 500. Specifically, referring to FIG. 6, the polygon manipulating means 112 translates the polygons 10, 20, 30 and 40 so as to increase the x-coordinate of each point on the face image 500 and decrease the z-coordinate of each point on the face image 500 in the step S7. A distance d traveled by each of the polygons 10, 20, 30 and 40 in the direction of the x-axis and a distance e traveled by each of the polygons 10, 20, 30 and 40 in the direction of the z-axis are represented by the following equations (10) and (11), respectively.

d=a/4 (10)

e=(1−cos θ)/2 (11)

Coordinate transformation of each of the polygons 10, 20, 30 and 40 associated with the translation in the step S7 is accomplished by using the following matrix (12).

$$[ \begin{matrix}1 & 0 & 0 & e \\ 0 & 1 & 0 & 0 \\ 0 & 0 & 1 & - d \\ 0 & 0 & 0 & 1\end{matrix} ] \qquad ( 12 )$$

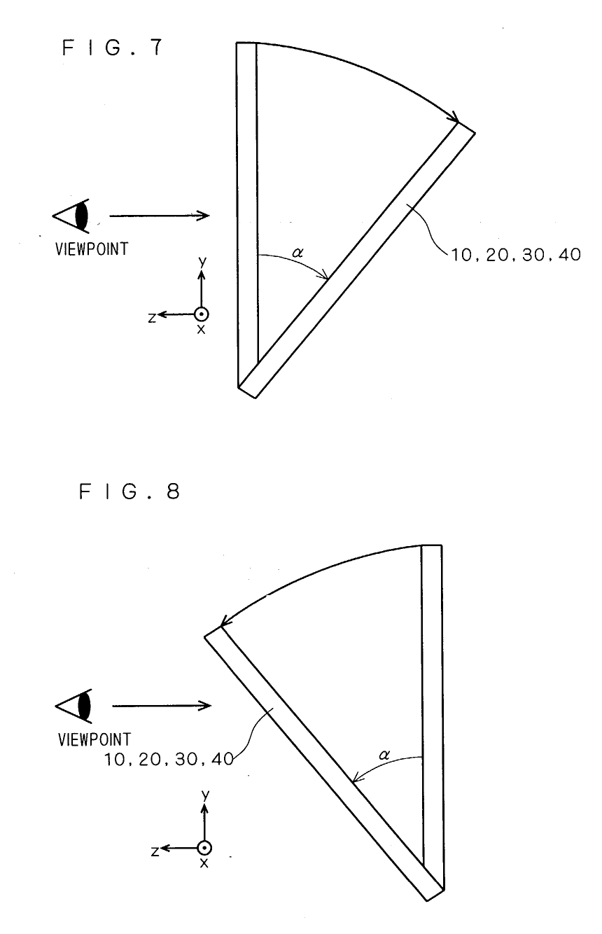

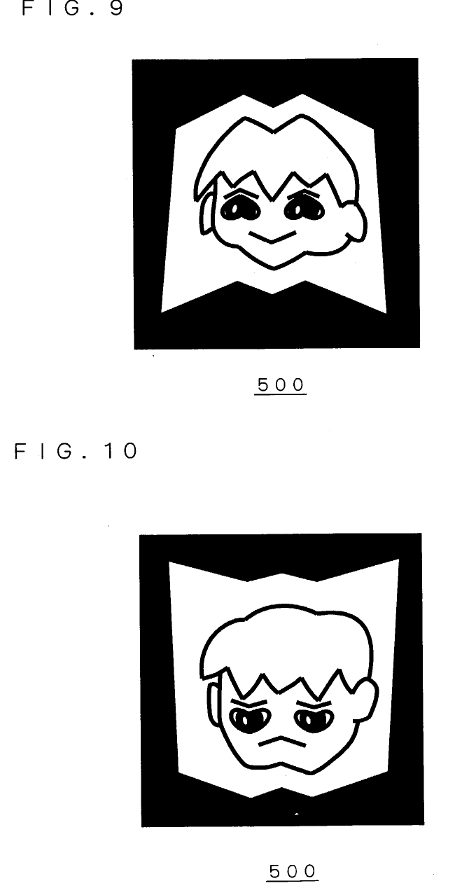

In the step S8, the polygon manipulating means 112 rotates each of the polygons 10, 20, 30 and 40 about the x-axis, i.e., in a direction of a line of vision, at the rotation angle α, to vary expression of the face in the face image 500. FIG. 7 illustrates the rotated polygons 10, 20, 30 and 40, as compared with the polygons prior to the rotation, which are viewed from a positive direction of the x-axis when the rotation angle α is negative. FIG. 8 illustrates the rotated polygons 10, 20, 30 and 40, as compared with the polygons prior to the rotation, which are viewed from a positive direction of the x-axis when the rotation angle α is positive. Coordinate transformation of each of the polygons 10, 20, 30 and 40 associated with the rotation in the step S8 is accomplished by using the following matrix (13).

$$[ \begin{matrix}1 & 0 & 0 & 0 \\ 0 & cos α & - sin α & 0 \\ 0 & sin α & cos α & 0 \\ 0 & 0 & 0 & 1\end{matrix} ] \qquad ( 13 )$$

In the step S9, the polygon manipulating means 112 projects the polygons 10, 20, 30 and 40 onto the x-y plane by means of perspective projection. In displaying an object disposed in a three-dimensional space using the image display device 150 as a two-dimensional display system, perspective projection which is known in the field of 3-D graphics is typically employed. Perspective projection, in which a portion of the object located far from a viewer is displayed in a size smaller than another portion of the object located closer to the viewer, makes an image of the object more realistic. Thus, the projected face image 500 is displayed with perspective, to give the viewer the illusion under which the viewer feels as if he really held and bent the face image 500 in his hands and observed the face image 500 with his eyes being directed obliquely downward or upward. Coordinate transformation of each of the polygons 10, 20, 30 and 40 associated with the perspective projection is accomplished by using the following matrix (14).

$$[ \begin{matrix}\frac{2 n}{r - 1} & 0 & \frac{r + 1}{r - 1} & 0 \\ 0 & \frac{2 n}{t - b} & \frac{t + b}{t - b} & 0 \\ 0 & 0 & \frac{- ( f + n )}{f - n} & \frac{- 2 fn}{f - n} \\ 0 & 0 & - 1 & 0\end{matrix} ] \qquad ( 14 )$$

In the matrix (14): 1 indicates a coordinate at a left edge of a view volume provided in the perspective projection; r indicates a coordinate at a right edge of the view volume; t indicates a coordinate at a top edge of the view volume; b indicates a coordinate at a bottom edge of the view volume; n indicates a coordinate at a front edge (near the viewer) of the view volume; and f indicates a coordinate at a rear edge (far from the viewer) of the view volume.

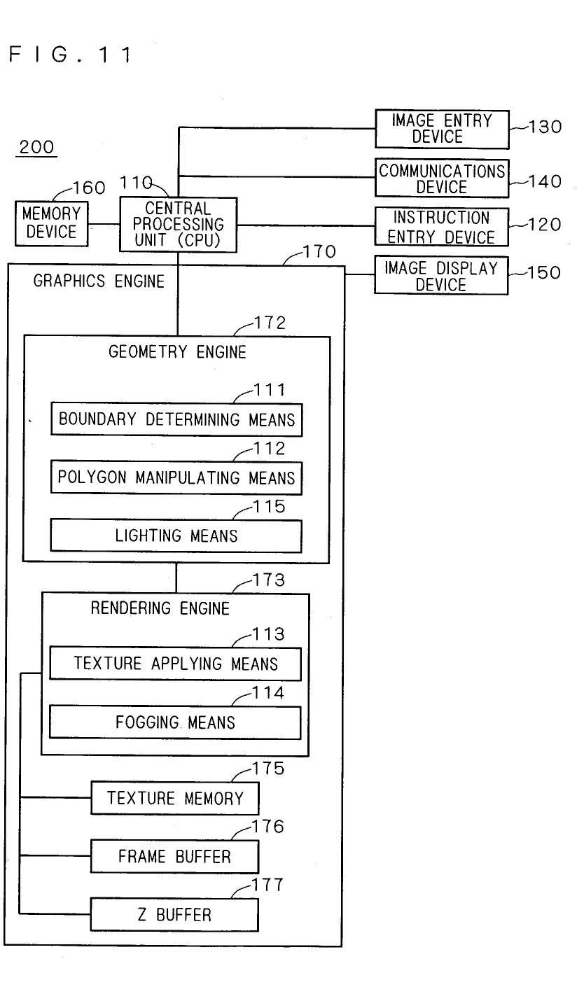

In the step S10, the texture applying means 113 applies the textures 50, 60, 70 and 80 each of which is a two-dimensional texture image, to the polygons 10, 20, 30 and 40, respectively (texture mapping). FIG. 9 shows the face image 500 resulted from applying the textures 50, 60, 70 and 80 to the polygons 10, 20, 30 and 40 illustrated in FIG. 7, respectively, and FIG. 10 shows the face image 500 resulted from applying the textures 50, 60, 70 and 80 to the polygons 10, 20, 30 and 40 illustrated in FIG. 8, respectively. Prior to applying the textures 50, 60, 70 and 80 to the polygons 10, 20, 30 and 40, respectively, the textures 50, 60, 70 and 80 must be transformed in accordance with final coordinates of the vertices of the polygons 10, 20, 30 and 40 which are provided after the coordinate transformations in the steps S5 through S8. The textures 50, 60, 70 and 80 are transformed by performing an interpolation calculation using original coordinates of the vertices of the polygons 10, 20, 30 and 40 which are provided prior to the coordinate transformations thereof, and the final coordinates of the vertices of the polygons 10, 20, 30 and 40. Then, the textures 50, 60, 70 and 80 as transformed are applied to the polygons 10, 20, 30 and 40 defined by the vertices having the final coordinates, respectively.

According to the procedures for the steps S5 through S10 described above, the coordinate transformations are carried out plural times using the respective matrices one by one. However, in a situation where all necessary parameters for coordinate transformations can be prepared as in the first preferred embodiment, a product of the matrices may be previously calculated by the central processing unit 110, from the matrices used for the respective coordinate transformations. In this manner, by merely performing one matrix operation using the original coordinates of the vertices of the polygons 10, 20, 30 and 40 which are provided before manipulating the face image 500, it is possible to calculate the final coordinates of the vertices of the polygons 10, 20, 30 and 40 which are to be provided after manipulating the face image 500.

According to the procedures for the steps S2 and S3 described above, the bending angle θ and the rotation angle α are obtained by having the user directly enter corresponding values through the instruction entry device 120. However, the bending angle θ and the rotation angle α may be obtained in an alternative manner. In the alternative manner, while the bending angle θ or the rotation angle α is increased in proportion to a period of time during which a predetermined key of the instruction entry device 120 is being pressed down by the user, the user observes the face image 500 which is varying in accordance with the increase of the bending angle θ or the rotation angle α, on the image display device 150, and stops pressing down the predetermined key at a time when the bending angle θ or the rotation angle α has an arbitrary value, to determine the bending angle θ and the rotation angle α to be actually employed.

Further, according to the procedures for the step S4 described above, the boundary determining means 111 determines the coordinate eM using the equation (1). However, the coordinate eM may be determined alternatively by having the user arbitrarily specify the coordinate eM, without using the equation (1). Also, determination of the coordinates eL and eR may be achieved in alternative manners as follows. In one alternative manner, the user arbitrarily specifies arbitrary positions on the face image 500 as the coordinates eL and eR without taking into account the positions of the left and right eyes of the face in the face image 500. In a second alternative manner, the user is not required to specify the coordinates eL and eR in any way. Instead, the boundary determining means 111 identifies the features of the shape and color of each eye (i.e., a state in which a black circular portion is surrounded by a white portion) of the face in the face image 500 by carrying out image processing using distribution of intensity of a black color, for example, to automatically determine the coordinates eL and eR. In employing the second alternative manner, however, a range of the size of the face image and the orientation of the face in the face image should be limited to that which allows the boundary determining means 111 to perceive the eyes of the face in the face image so as to automatically determine the coordinates eL and eR.

According to the procedure for the step S3 described above, the user enters the rotation angle α at which the face image 500 is to be rotated about the x-axis. Alternatively, the user can establish an operation mode in which the rotation angle α for the face image 500 is continuously varied. This makes it possible to continuously vary the expression of the face in the face image 500, thereby to keep interesting the user for a longer period of time.

Moreover, the user can optionally carry out fogging on the face image 500 using the fogging means 114 in order to enhance a perspective effect, as a step S8-1, prior to the step S9. Fogging is a technique of fading a portion of an object in an image which is located far from a viewpoint, by changing a color tone of the portion, as represented by the following equation (15).

c=f×Ci+(1−f)×Cf (15)

In the equation (15): c indicates a color tone; f indicates a fog coefficient; Ci indicates a color of an object in an image (i.e., the polygons 10, 20, 30 and 40 having the textures 50, 60, 70 and 80 applied thereto, respectively); and Cf indicates a color of a fog used for fogging. The fog coefficient f may be exponentially decayed in accordance with a distance z between the viewpoint and each of the polygons 10, 20, 30 and 40 during the rotation at the rotation angle α in the step S8 (by using a user-determined coefficient density as a proportionality constant, as represented by the following equation (16), for example). Fogging provides for more realistic display.

f=e^{-(density×z)} (16)

The user can further optionally carry out lighting (see “OpenGL Programming Guide”, published by Addison-Wesley Publishing Company, pp. 189-192) as a step S8-2 prior to the step S9. In the lighting of the step S8-2, a color of an object in an image is changed or highlights is produced in an object in an image, so that the object looks as if it received a light. Specifically, the lighting means 115 changes colors of the textures 50, 60, 70 and 80 to be applied to the polygons 10, 20, 30 and 40, respectively, in accordance with coordinates of the viewpoint, coordinates of a light source and the final coordinates of the vertices of the polygons 10, 20, 30 and 40 which are provided after the rotation at the angle α. The lighting produces difference in brightness throughout the face image 500, to provide for more realistic display, so that the user can feel as if he observed the face image 500 really in his hands while letting the image receive a light from a predetermined direction.

By the foregoing steps S4 through S10, manipulation of the face image 500 is completed. Then, in a step S11, a check as to whether or not the user changes the operation mode or parameters (the bending angle θ, the rotation angle α) through the instruction entry device 120 is made. If it is found that the user changes the operation mode or parameters, the process flow returns back to the step S5, to again initiate manipulation of the face image 500.

In a step S12, a check as to whether or not the user enters an instruction for storing a manipulated version of the face image 500 through the instruction entry device 120 is made. If the instruction for storing the manipulated version of the face image 500 is entered by the user, the process flow advances to a step S15, where the manipulated version of the face image 500 is stored. The manipulated version of the face image 500 may be stored in a data format originally employed in the manipulated version of the face image 500, or alternatively be stored in a different data format including the original of the face image 500 prior to manipulation thereof, the bending angle θ and the rotation angle α. To store the manipulated version of the face image 500 in the data format originally employed in the manipulated version of the face image 500 is advantageous in that the face image 500 can be displayed also on a separate image display equipment (a personal computer, a mobile phone or the like) which does not include the image manipulating apparatus 100 according to the first preferred embodiment when the face image 500 as stored is transmitted to the separate image display equipment using the communications device 140. On the other hand, to store the manipulated version of the face image 500 in the data format including the original of the face image 500, the bending angle θ and the rotation angle α would eliminate a need of having the user enter the bending angle θ and the rotation angle α in the steps S2 and S3. In such a case, values stored to be used for composing the data format are employed in the steps S2 and S3.

In a step S13, a check as to whether or not the user enters an instruction for switching the original of the face image 500 for another one, through the instruction entry device 120 is made. If the instruction for switching the original of the face image 500 for another one is entered by the user, the process flow returns back to the step S1, where another original of the face image 500 is entered. As described above, by previously entering and storing a plurality of face images as originals into the memory device 160 in the step S1, it is possible to facilitate a process for switching an original of the face image 500 for another one in the step S13.

In a step S14, a check as to whether or not the user enters an instruction for terminating the process flow shown in FIG. 2 through the instruction entry device 120 is made. If the instruction for terminating the process flow is entered by the user, the process flow is terminated. On the other hand, if the instruction for terminating the process flow is not entered, the process flow returns back to the step S11, to repeat from the step S11.

As described above, in the image manipulating apparatus 100 according to the first preferred embodiment, the face image 500 as entered is divided into the polygons 10, 20, 30 and 40, which are then bent and rotated in a three-dimensional space and projected onto a two-dimensional plane. Thereafter, the textures 50, 60, 70 and 80 are applied to the polygons 10, 20, 30 and 40, respectively. As such, the image manipulating apparatus 100 according to the first preferred embodiment can produce visual effects to keep interesting the user with simple processes.

### Second Preferred Embodiment

FIG. 11 is a view illustrating a structure of an image manipulating apparatus 200 according to a second preferred embodiment of the present invention. Elements identical to those illustrated in FIG. 1 are denoted by the same reference numerals in FIG. 11, and detailed description about those elements is omitted. The image manipulating apparatus 200 illustrated in FIG. 11 differs from the image manipulating apparatus 100 illustrated in FIG. 1 in that a graphics engine 170 used exclusively for carrying out manipulation of an image (image manipulation) is provided between the central processing unit 110 and the image display device 150.

The graphics engine 170 includes a geometry engine 172, a rendering engine 173, a texture memory 175, a frame buffer 176 and a Z-buffer 177. The geometry engine 172 functions to operate as the boundary determining means 111, the polygon manipulating means 112 and the lighting means 115 under control in accordance with respective predetermined programs. The rendering engine 173 functions to operate as the texture applying means 113 and the fogging means 114 under control in accordance with respective predetermined programs. The rendering engine 173 is connected to the texture memory 175, the frame buffer 176 and the Z-buffer 177.

In accordance with the second preferred embodiment, the steps S4 through S9 shown in the flow chart of FIG. 2 are performed by the geometry engine 172 which functions to operate as the boundary determining means 111 and the polygon manipulating means 112. The geometry engine 172 carries out the coordinates transformations of the polygons 10, 20, 30 and 40, to obtain the final coordinates of the vertices of the polygons 10, 20, 30 and 40.

Then, the step S10 shown in the flow chart of FIG. 2 is performed by the rendering engine 173 which functions to operate as the texture applying means 113. More specifically, the rendering engine 173 carries out an interpolation calculation for interpolating the textures 50, 60, 70 and 80 stored as original image data in the texture memory 175, and applies the interpolated textures 50, 60, 70 and 80 to the polygons 10, 20, 30 and 40 defined by the vertices having the final coordinates (hereinafter, referred to as “final polygons”), respectively. Display of the textures 50, 60, 70 and 80 on the image display device 150 is accomplished by writing coordinate values and color values of the textures 50, 60, 70 and 80 into the frame buffer 176. More specifically, first, the rendering engine 173 locates the textures 50, 60, 70 and 80 which have previously been stored in the texture memory 175, in accordance with the final coordinates of the vertices of the polygons 10, 20, 30 and 40 which are obtained from the geometry engine 172, respectively. Then, respective portions of textures which are to fill insides of the final polygons 10, 20, 30 and 40 are obtained in terms of coordinates of respective pixels of display, by carrying out an interpolation calculation using the final coordinates of the vertices of the polygons 10, 20, 30 and 40. Subsequently, color values of the respective portions of the textures which are to fill the insides of the final polygons 10, 20, 30 and 40 are written into the frame buffer 176, thereby to fill the insides of the final polygons 10,20, 30 and 40.

During writing of the color values, the rendering engine 173 further interpolates z-coordinate values of the vertices of the polygons 10, 20, 30 and 40, and writes them into the Z-buffer 177. However, the rendering engine 173 does not carry out this operation when a z-coordinate value to be written at one pixel position is smaller than a different z-coordinate value previously stored as a value at the same pixel position in the Z-buffer 177 so that a portion of a polygon having the z-coordinate value to be written is out of sight of the viewer because of presence of a portion of another polygon (which has the different z-coordinate value) in front of the portion having the z-coordinate value to be written, relative to a viewpoint. Accordingly, the rendering engine 173 can allow only an image located closest to a viewpoint to be displayed on the image display device 150.

Further, in carrying out an interpolation calculation for interpolating the textures 50, 60, 70 and 80, the rendering engine 173 can interpolate not only the coordinate values but also the color values of the textures 50, 60, 70 and 80. The color values of the textures 50, 60, 70 and 80 can be interpolated by carrying out filtering based on a color value of a portion of the textures located in the vicinity. As a result, texture mapping which provides for smooth variation in color is possible.

As described above, the image manipulating apparatus 200 according to the second preferred embodiment of the present invention includes the graphics engine 170 used exclusively for image manipulation, and thus can produce further advantages in addition to the same advantages as produced in the first preferred embodiment. Specifically, an operation speed of image manipulation is increased, and other processes than a process of manipulating an image can be carried out in parallel in the central processing unit 110. Image manipulation described in the first preferred embodiment is accomplished by combination of coordinate transformation and texture mapping, both of which are typical techniques in the field of 3-D graphics. As such, by further including a hardware used exclusively used for image manipulation such as the graphics engine 170, it is possible to deal with a 3-D graphics process of a type different from that described above, so that various types of image processings can be carried out.

While the invention has been shown and described in detail, the foregoing description is in all aspects illustrative and not restrictive. It is therefore understood that numerous modifications and variations can be devised without departing from the scope of the invention.

What is claimed is:

1. An image manipulating apparatus comprising:
image entering means for allowing a two-dimensional image to be entered;
image storing means for storing said two-dimensional image entered through said image entering means;
boundary determining means for determining a boundary used for bending said two-dimensional image, on said two-dimensional image stored in said image storing means;
image manipulating means for bending said two-dimensional image about said boundary at a desired bending angle and rotating said two-dimensional image about a predetermined rotation axis at a desired rotation angle in a three-dimensional space, to create an image, said predetermined rotation axis defining a rotation of said-two dimensional image in a direction of a line of a vision; and
image displaying means for displaying said image created by said image manipulating means.

2. The image manipulating apparatus according to claim 1, wherein
said two-dimensional image is a two-dimensional image of a face,
said boundary determining means determines a plurality of boundaries including said boundary, and
said plurality of boundaries are determined in a plurality of positions on said face of said two-dimensional image, said plurality of positions including a position where an eye of said face is located.

3. The image manipulating apparatus according to claim 1, wherein
said boundary determining means includes means for calculating a position of said boundary from distribution of density of colored pixels of said two-dimensional image stored in said image storing means.

4. The image manipulating apparatus according to claim 1, wherein
said rotation angle is continuously varied.

5. The image manipulating apparatus according to claim 1, wherein
said image storing means stores a plurality of two-dimensional images including said two-dimensional image which are entered through said image entering means.

6. The image manipulating apparatus according to claim 1, further comprising
lighting means for carrying out lighting on said image created by said image manipulating means.

7. The image manipulating apparatus according to claim 1, further comprising
fogging means for carrying out fogging on said image created by said image manipulating means.

8. The image manipulating apparatus according to claim 1, further comprising
communications means for transmitting and receiving said two-dimensional image manipulated by said image manipulating apparatus.

9. The image manipulating apparatus according to claim 1, further comprising
communications means for transmitting and receiving data including said two-dimensional image entered through said image entering means, said bending angle and said rotation angle.
